(19) United States
(12) Patent Application Publication
(10) Pub. No.: US 2025/0142263 A1
(43) Pub. Date: May 1, 2025

(54) PIEZOELECTRIC SPEAKER AND METHOD FOR MANUFACTURING THE SAME

(71) Applicant: National Tsing Hua University, Hsinchu (TW)

(72) Inventors: Shu-Wei Chang, Hsinchu (TW); Chin Tseng, Hsinchu (TW); Ting-Chou Wei, Hsinchu (TW); Sung Cheng Lo, Hsinchu (TW); Weileun Fang, Hsinchu (TW)

(73) Assignee: National Tsing Hua University, Hsinchu (TW)

(21) Appl. No.: 18/411,408

(22) Filed: Jan. 12, 2024

(30) Foreign Application Priority Data
Oct. 31, 2023 (TW) 112141859

(51) Int. Cl. H04R 17/00; H04R 1/02; H04R 31/00

(52) U.S. Cl. CPC H04R 17/00; H04R 1/02; H04R 31/00

(57) ABSTRACT

A piezoelectric speaker includes: a peripheral rectangular frame having four sides; a central rectangular frame disposed on the peripheral rectangular frame, wherein the central rectangular frame has four corners and four sides, and the four corners are connected to the four sides of the peripheral rectangular frame; four central triangular cantilevers disposed within the central rectangular frame, wherein each of the central triangular cantilevers has a vibrating end and a fixed end opposite to the vibrating end, and each of the fixed ends of the central triangular cantilevers is connected to the four sides of the central rectangular frame, the four vibrating ends of the four central triangular cantilevers are close to each other, and the four central triangular cantilevers have different dimensions of their respective areas defined within the central rectangular frame; and four peripheral triangular cantilevers disposed between the peripheral rectangular frame and the central rectangular frame.

### CROSS REFERENCE TO RELATED APPLICATIONS

The application claims the benefit of Taiwan Patent Application No. 112141859, filed on Oct. 31, 2023, at the Taiwan Intellectual Property Office, the disclosures of which are incorporated herein in their entirety by reference.

### FIELD OF THE INVENTION

The present invention relates to a speaker, in particular a piezoelectric speaker used in True Wireless Stereo Headphones.

### BACKGROUND OF THE INVENTION

As consumer electronics become more sophisticated and miniaturized, micro-electromechanical systems (MEMS) are also receiving more attention. Lead zirconate titanate (Pb(ZrₓTi₁₋ₓ)O₃, PZT) material has good piezoelectric properties and is easy to combine with silicon micro fabrication, so it is widely used in fields such as micro speakers (piezoelectric speakers).

In the application of true wireless Bluetooth earbuds, due to the limited internal space of the earbuds, it is difficult to further reduce the dimension of traditional speakers, so micro speakers developed with micro-electromechanical technology have emerged. To minimize the dimension of the speaker, while expanding the bandwidth and maintaining sufficient sound pressure level to improve the performance of the speaker, has become an urgent problem to be solved in this field. In addition, when a speaker has multiple diaphragms and the driving frequency exceeds its resonant frequency, the out-of-phase vibration between the diaphragms may decrease the sound pressure level.

### SUMMARY OF THE INVENTION

The present invention provides a micro speaker with a special structural design that can simultaneously expand the bandwidth and maintain sufficient sound pressure level in a dimension that meets the requirements of true wireless Bluetooth earbuds.

In accordance with one aspect of the present invention, a piezoelectric speaker is disclosed. The piezoelectric speaker includes a peripheral rectangular frame having four sides; a central rectangular frame disposed on the peripheral rectangular frame, wherein the central rectangular frame has four corners and four sides, and the four corners are connected to the four sides of the peripheral rectangular frame; four central triangular cantilevers disposed within the central rectangular frame, wherein each of the central triangular cantilevers has a vibrating end and a fixed end opposite to the vibrating end, and each of the fixed ends of the central triangular cantilevers is connected to the four sides of the central rectangular frame, the four vibrating ends of the four central triangular cantilevers are close to each other and fall short of contacting with each other, and the four central triangular cantilevers have different dimensions of their respective areas defined within the central rectangular frame; and four peripheral triangular cantilevers disposed between the peripheral rectangular frame and the central rectangular frame, wherein each of the four peripheral triangular cantilevers has a vibrating end and a fixed end opposite to the vibrating end, and the fixed ends of the four peripheral triangular cantilevers are respectively connected to the four sides of the central rectangular frame.

In accordance with another aspect of the present invention, a method for manufacturing a piezoelectric speaker is disclosed. The method includes the steps of: (a) depositing a bottom electrode layer on a substrate and depositing a piezoelectric layer on the bottom electrode layer; (b) etching the piezoelectric layer to form a plurality of cantilever precursors; (c) forming a top electrode layer on the etched piezoelectric layer and patterning the top electrode layer; (d) patterning a first portion of the substrate and the bottom electrode layer; and (e) etching a second portion of the substrate to form a geometric frame, wherein the plurality of cantilever precursors are connected to the geometric frame to form a plurality of cantilevers, and the sides of the geometric frame present a form of a closed geometric figure.

In accordance with a further aspect of the present invention, a piezoelectric speaker is disclosed. The piezoelectric speaker includes a frame having a sub-frame in a specific shape; and at least three inner cantilevers disposed in the frame, wherein each of the cantilevers has a vibrating end and a fixed end, each of the fixed ends of the cantilevers is connected to the sub-frame of the frame, areas respectively defined by the cantilevers within the frame have at least three dimensions, so that the piezoelectric speaker has at least three resonant frequencies.

### BRIEF DESCRIPTION OF THE DRAWINGS

Other objectives, advantages and efficacies of the present invention will be described in detail below taken from the preferred embodiments with reference to the accompanying drawings.

FIG. 1 is a schematic top view of a piezoelectric speaker according to an embodiment of the present invention.

FIG. 2 is a schematic top view of the piezoelectric speaker with a slit according to an embodiment of the present invention.

FIG. 3 is a cross-sectional view along line A-A′ of the piezoelectric speaker according to the embodiment of the present invention.

FIG. 4 shows cross-sectional views illustrating structural changes of the piezoelectric speaker after performing four processing steps of the manufacturing method of the piezoelectric speaker.

FIG. 5 is a graph showing slit length and resonance frequency according to the embodiment of the present invention.

FIG. 6(a) is a schematic diagram of a reference type piezoelectric speaker used for comparison with the embodiments of the present invention.

FIG. 6(b) is a simulation graph illustrating the sound pressure level performances of the piezoelectric speaker of the embodiment driven by the in-phase driving type and the reference type piezoelectric speaker.

FIG. 6(c) is a simulation graph illustrating the sound pressure level performances of the piezoelectric speaker of the embodiment driven by the out-of-phase driving type and the reference type piezoelectric speaker.

FIG. 6(d) is a simulation graph illustrating the sound pressure level performances of the piezoelectric speaker of the embodiment driven by the in-phase driving type and the out-of-phase driving type piezoelectric speaker.

FIG. 6(e) is a schematic diagram of the out-of-phase driving method for the piezoelectric speaker embodiment of FIG. 6(a).

FIG. 7(a) is a measurement graph illustrating the sound pressure level performance of the piezoelectric speaker of another embodiment driven by the in-phase driving type and the reference type piezoelectric speaker.

FIG. 7(b) is a measurement graph illustrating the sound pressure level performance of the piezoelectric speaker of another embodiment driven by the out-of-phase driving type and the reference type piezoelectric speaker.

FIG. 7(c) is a measurement graph illustrating the sound pressure level performance of the piezoelectric speaker of another embodiment driven by the in-phase driving type and the out-of-phase driving type piezoelectric speaker.

### DETAILED DESCRIPTION OF THE PREFERRED EMBODIMENTS

The technical content, features and effects of the present invention will be clearly presented by the following detailed descriptions of preferred embodiments.

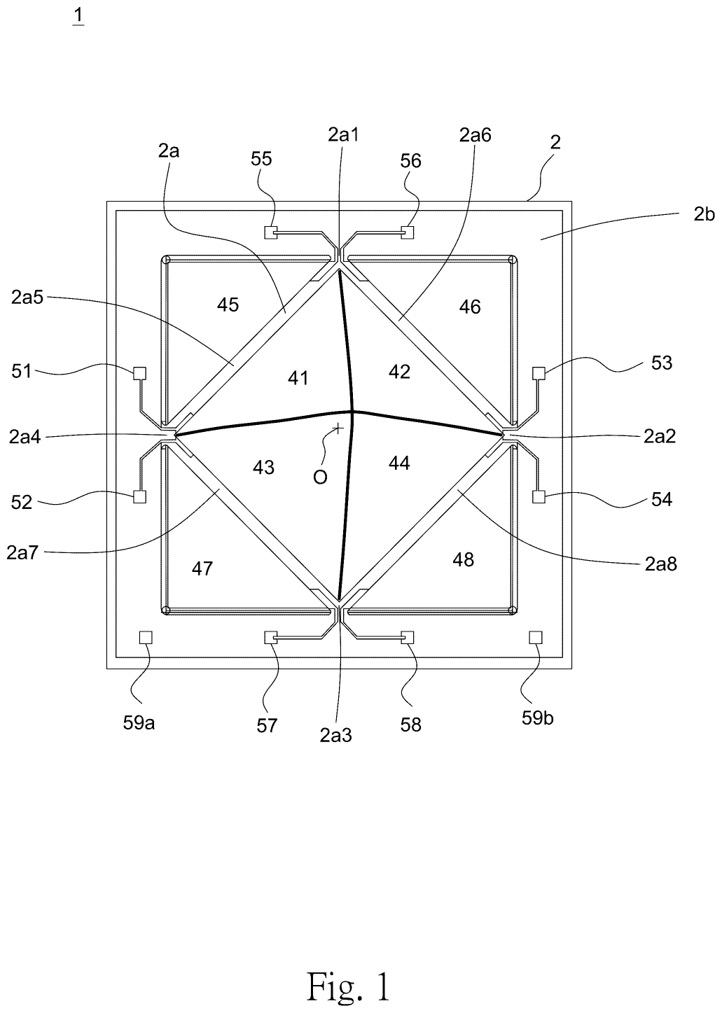

Please refer to FIG. 1, which is a schematic top view of a piezoelectric speaker 1 according to an embodiment of the present invention. The piezoelectric speaker 1 includes a rectangular frame 2, eight triangular cantilevers 41-48, and feed lines 51-58. The ground electrodes 59a, 59b are disposed on the rectangular frame 2. The rectangular frame 2 has a central rectangular frame 2a and a peripheral rectangular frame 2b. The central rectangular frame 2a is disposed within the peripheral rectangular frame 2b. The central rectangular frame 2a has four corners 2a1-2a4 and four sides 2a5-2a8. The peripheral rectangular frame 2b has four sides. The four corners 2a1-2a4 of the central rectangular frame 2a are respectively connected to the four sides of the peripheral rectangular frame 2b.

The eight triangular cantilevers 41-48 are made of piezoelectric material and include four central triangular cantilevers 41-44 and four peripheral triangular cantilevers 45-48. The central triangular cantilevers 41-44 are disposed in the central rectangular frame 2a. The central triangular cantilevers 41-44 and the peripheral triangular cantilevers 45-48 have fixed ends and vibrating ends. Each fixed end of the central triangular cantilevers 41-44 is respectively connected to the four sides 2a5-2a8 of the central rectangular frame 2a. The vibrating ends are close to each other but do not overlap. The respective areas defined by the central triangular cantilevers 41-44 in the central rectangular frame 2a have at least four dimensions, so that the central triangular cantilevers 41-44 contribute four resonant frequencies to the piezoelectric speaker 1, that is, the central triangular cantilevers 41-44 respectively correspond to the four resonant frequencies. Each vibrating end of the four central triangular cantilevers 41-44 can jointly define a central area, and a geometric center C of the central area does not overlap with a geometric center O of the central rectangular frame 2a. As an example, in this embodiment, the geometric center defined by the central triangular cantilevers 41-44 of the piezoelectric speaker 1 chip with a cross-sectional area of 4×4 mm² is moved 40 μm to the right and 200 μm upward compared to the geometric center O.

The peripheral triangular cantilevers 45-48 are disposed between the central rectangular frame 2a and the peripheral rectangular frame 2b. Each fixed end of the peripheral triangular cantilevers 45-48 is also connected to the four sides 2a5-2a8 of the central rectangular frame 2a, but the fixed ends of the peripheral triangular cantilevers 45-48 are connected to the outer side of the four sides 2a5-2a8. Each fixed end of the cantilevers 41-44 is connected to the inner side of the four sides 2a5-2a8.

The eight feed lines 51-58 respectively pass through the four corners 2a1-2a4 of the central rectangular frame 2a and connect to the four central triangular cantilevers 41-44 and the four peripheral triangular cantilevers 45-48 respectively. Driving signals (for example, driving voltage signals) are applied to the central triangular cantilevers 41-44 and the peripheral triangular cantilevers 45-48 through the feed lines 51-58 to vibrate the vibrating end of the piezoelectric material to generate vibration and sound. Because the dimensions of the four central triangular cantilevers 41-44 are different, they can contribute four resonant frequencies or four sound pressure level poles (SPL poles) to the piezoelectric speaker 1 and then by adjusting the driving signal method to expand the bandwidth and maintain sufficient sound pressure level. However, because the dimensions of the four peripheral triangular cantilevers 45-48 in FIG. 1 are the same, the resonant frequencies generated by the peripheral triangular cantilevers 45-48 are the same. If the peripheral triangular cantilevers 45-48 are allowed to contribute different resonance frequencies or sound pressure level poles to the piezoelectric speaker 1, in addition to changing the size of the cantilevers, slits can also be disposed.

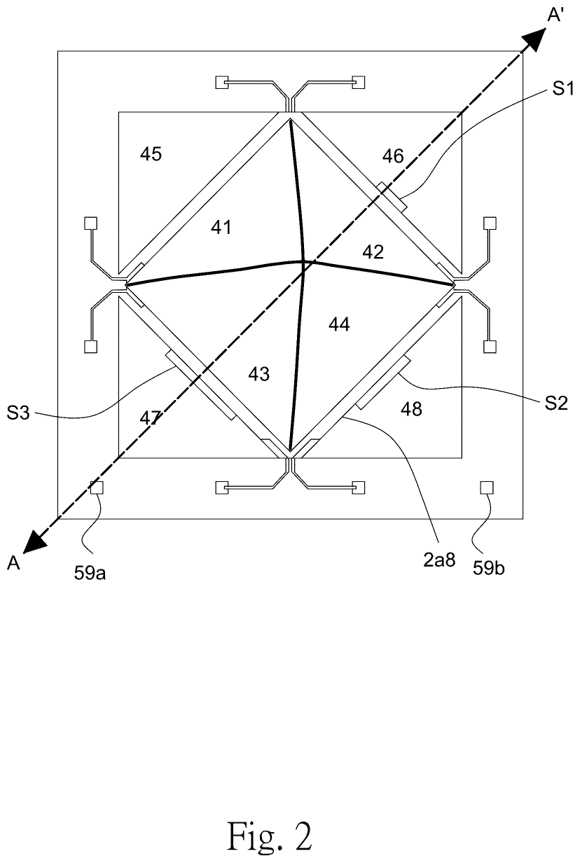

Please refer to FIG. 2, which is a schematic top view of the piezoelectric speaker 1 with a slit according to an embodiment of the present invention. As shown in FIG. 2, the slits S1, S2 and S3 between the peripheral rectangular frame 2b and the central rectangular frame 2a, are respectively disposed adjacent to the three sides 2a6, 2a7 and 2a8 of the central rectangular frame 2a (as shown in FIG. 1). Each of the slits has a length in direction extending parallel to each side 2a6, 2a7 and 2a8 of the central rectangular frame 2a, respectively. The slit S3 has the longest length, the slit S2 has the second longest length, and the slit S1 has the shortest length. The length is negatively correlated with the resonance frequency corresponding to the peripheral triangular cantilevers 46, 47 and 48. By disposing the slits S1, S2 and S3, the peripheral triangular cantilevers 45-48 can contribute four different resonance frequencies to the piezoelectric speaker 1.

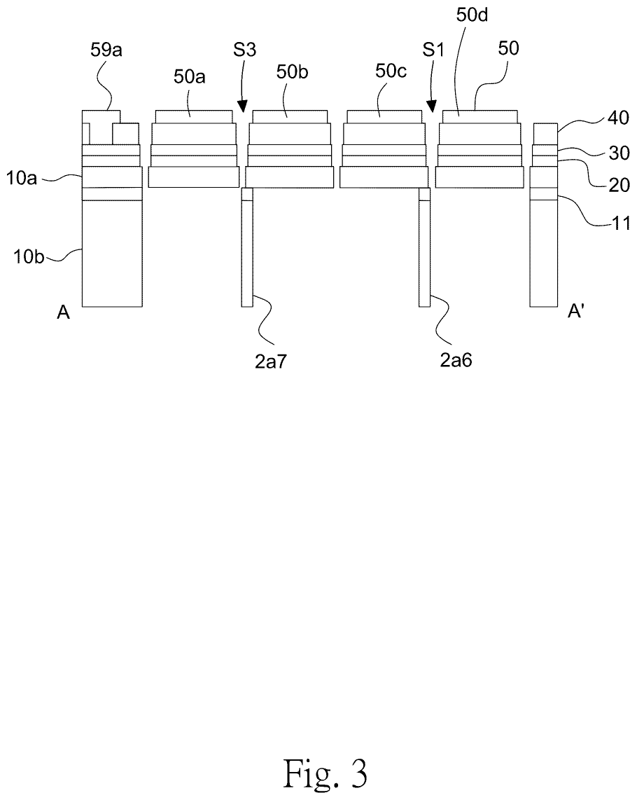

In order to understand the cross-sectional structure of the piezoelectric speaker 1 more clearly, please refer to FIG. 3. FIG. 3 is a cross-sectional view along line A-A′ of the piezoelectric speaker 1 according to the embodiment of the present invention. In FIG. 3, two slits S1 and S3 are respectively disposed near the two sides 2a6 and 2a7 of the central rectangular frame 2a. The cross-sectional structure of the piezoelectric speaker 1 includes, from the top to the bottom, a top electrode layer 50 (including top electrodes 50a˜50d and ground electrodes 59a, 59b), a piezoelectric layer 40, a bottom electrode layer 30, an adhesion layer 20, an upper silicon device layer 10a, the middle silicon dioxide layer 11 and a lower silicon device layer 10b. The upper silicon device layer 10a, the middle silicon dioxide layer 11, and the lower silicon device layer 10b are collectively called a substrate and are made of SOI wafers. Referring to FIG. 2 and FIG. 3, the top electrodes 50a-50d are electrically connected to the feed lines 57, 52, 53, and 56, respectively, and the ground electrode 59a is electrically connected to the bottom electrode layer 30.

The top electrode layer 50 and the bottom electrode layer 30 may be made of conductive material, preferably PZT (lead zirconate titanate) material in addition to other typical piezoelectric materials such as AlN, ZnO and TiBaO3. In this embodiment, the top electrode layer 50 is made of gold (Au), and the bottom electrode layer 30 is made of platinum (Pt). The adhesion layer 20 is disposed between the upper silicon device layer 10a and the bottom electrode layer 30. In this embodiment, the adhesion layer 20 is made of zirconium dioxide (ZrO2). The piezoelectric layer 40 is disposed between the top electrode layer 50 and the bottom electrode layer 30. In this way, by applying a voltage to the electrode layer, the electrical energy is converted into the mechanical energy of the piezoelectric layer elongation, thereby generating vibration.

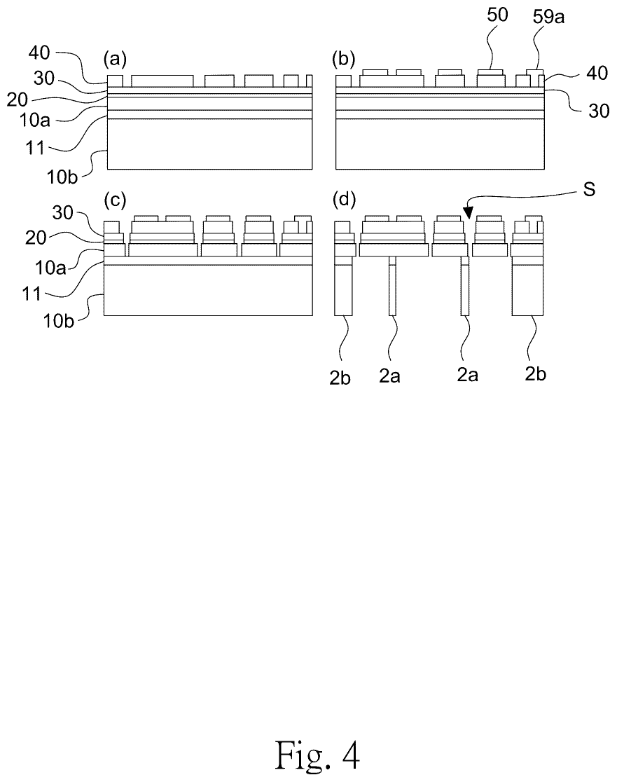

Please refer to FIG. 4, which shows cross-sectional views of the structural changes of the piezoelectric speaker 1 after the four processing steps of the manufacturing method of the piezoelectric speaker 1. First, an adhesion layer 20, a bottom electrode layer 30 and a piezoelectric layer 40 are sequentially deposited on a substrate, where the substrate has a lower silicon device layer 10b, a middle silicon dioxide layer 11 and an upper silicon device layer 10a (figure not shown).

Then, as shown in FIG. 4(a), the piezoelectric layer 40 is wet-etched with hydrochloric acid and hydrofluoric acid to form a plurality of triangular cantilever precursors (not shown in the cross-sectional view of FIG. 4(a)). Next, as shown in FIG. 4(b), the top electrode layer 50 is formed on the piezoelectric layer 40 by evaporation deposition, and then the top electrode layer 50 is patterned and feed lines are formed (not shown in the cross-sectional view of FIG. 4(b)). Next, as shown in FIG. 4(c), a high-density reactive ion etching system (HDP-RIE) is used to dry-etch the upper silicon device layer 10a of the substrate, the adhesion layer 20 and the bottom electrode layer 30 on the substrate. Finally, as shown in FIG. 4(d), different from the previous steps, the middle silicon dioxide layer 11 and the lower device layer 10b of the substrate are deep reactive ion etched (DRIE) from the other side to form the peripheral rectangular frame 2b and central rectangular frame 2a, and to complete the slits S.

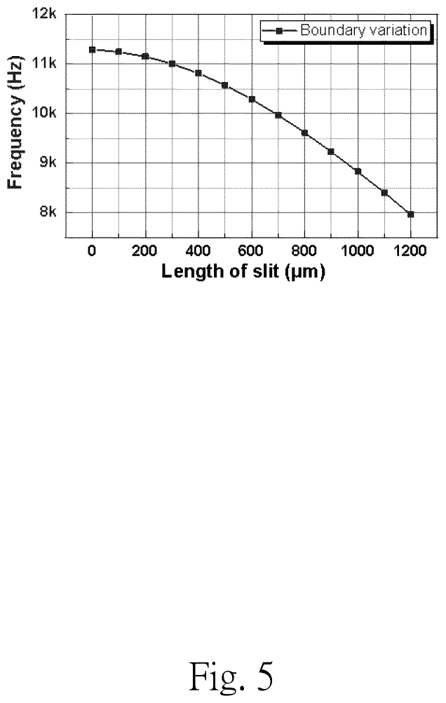

Please refer to FIG. 5, which is a graph of slit length and resonant frequency according to an embodiment of the present invention. It can be seen from FIG. 5 that the longer the slit length is, the smaller the resonant frequency of the cantilever is. Compared with the four central triangular cantilevers whose resonant frequencies are modulated by changing the area (domain variation), the resonant frequencies of the peripheral triangular cantilevers are modulated by changing the slit length (boundary variation). In this embodiment, the lengths of the slits S1, S2, and S3 are 300 μm, 600 μm, and 900 μm, respectively. These lengths can be adjusted according to needs, and the preferred range is 200-1200 μm and the more preferred range is 300-900 μm. As for the slit width, it cannot exceed 5 μm. If the width exceeds 5 μm, serious sound leakage may occur, affecting the overall performance of the micro speaker. In an embodiment, the cross-sectional area size of the micro speaker chip can be between 9 and 16 mm².

The cross-sectional area size of the piezoelectric speaker 1 in this embodiment is 4×4 mm², and the equivalent diaphragm area of the eight triangular cantilevers 41-48 is 8 mm². The cantilever is fixed on a central rectangular frame with a width of 100 μm. The wider the frame width is, the smaller the interaction between the cantilever diaphragm inside and outside the frame is, but it will lead to an increase in the overall area of the piezoelectric speaker. The cantilevers within the frame are designed with different dimensions (domain variation) to produce their different resonant frequencies. Because the cantilever in this embodiment is triangular, there is a length from the vertex of the triangular cantilever to the opposite side (i.e., the height line H of the triangle), and the square of the length is inversely proportional to the resonant frequency of the triangular cantilever. Therefore, in this embodiment, the resonant frequencies of the central triangular cantilevers 41-44 are 14.0 KHz, 15.8 kHz, 8.3 kHz and 9.6 kHz, respectively, and the resonant frequencies of the peripheral triangular cantilevers 45-48 are 11.3 kHz, 10.9 kHz, 9.1 kHz and 10.3 kHz, respectively.

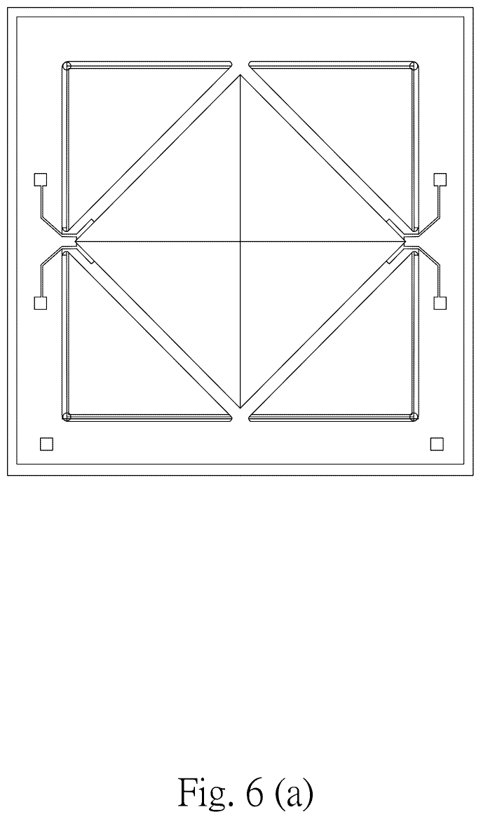

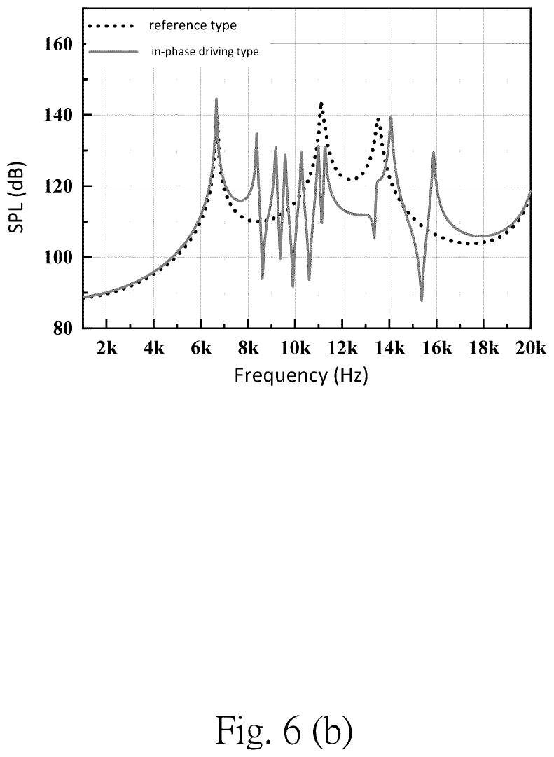

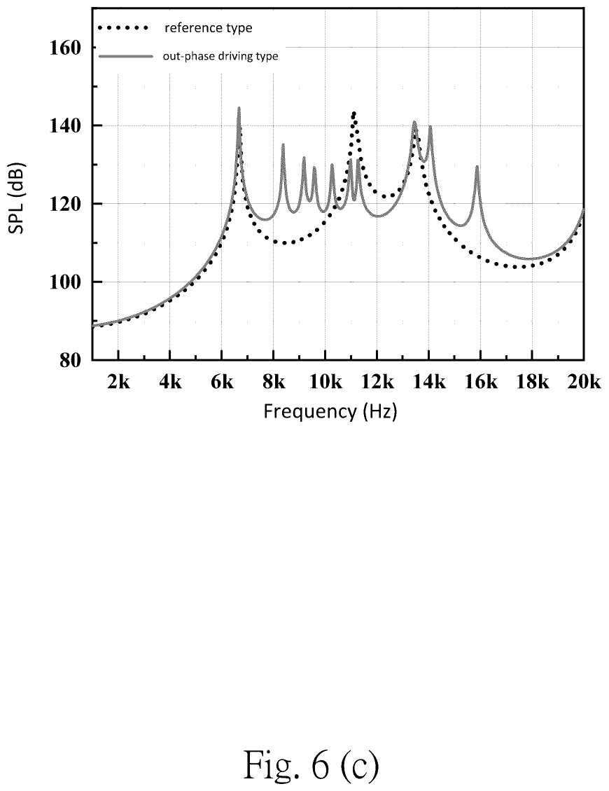

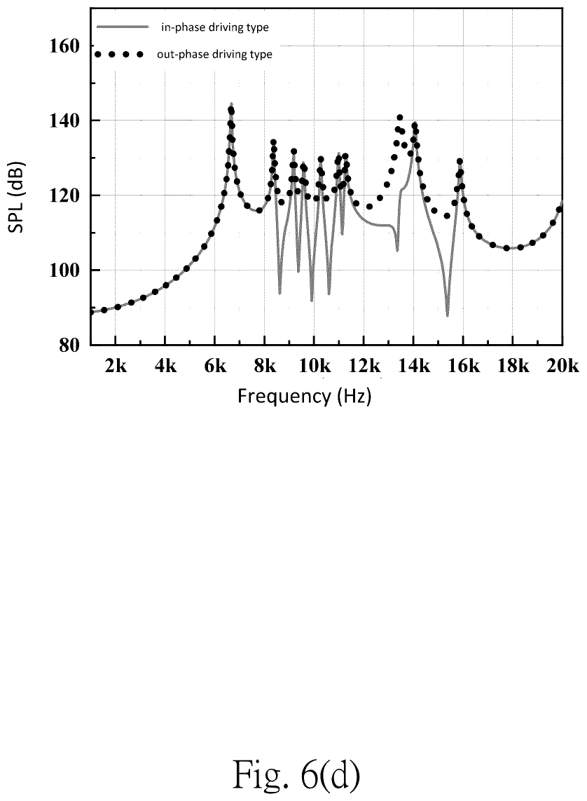

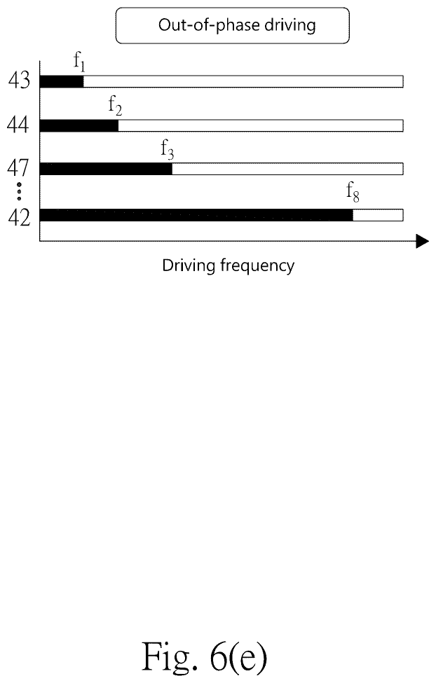

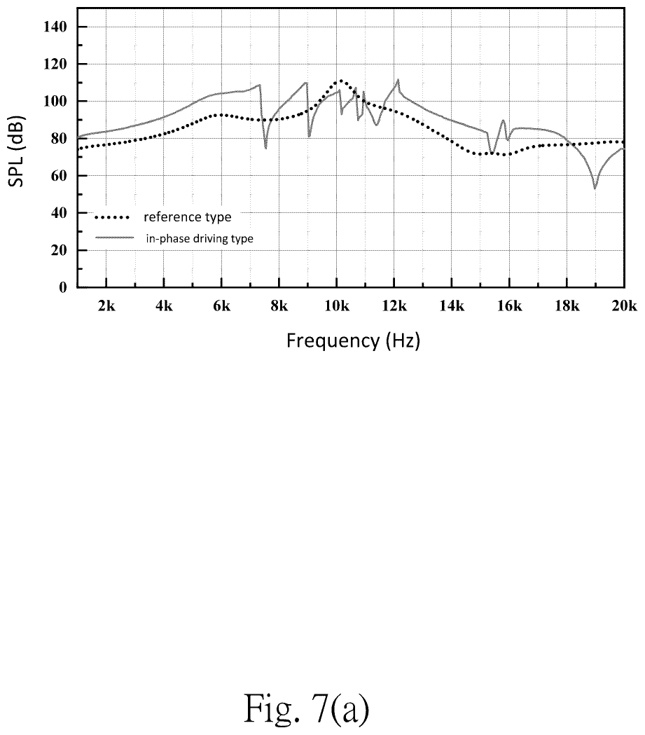

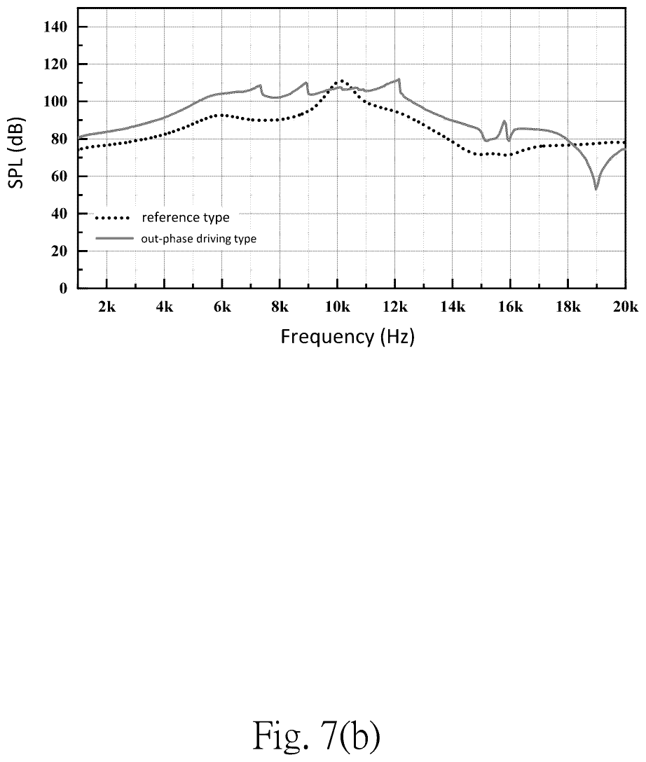

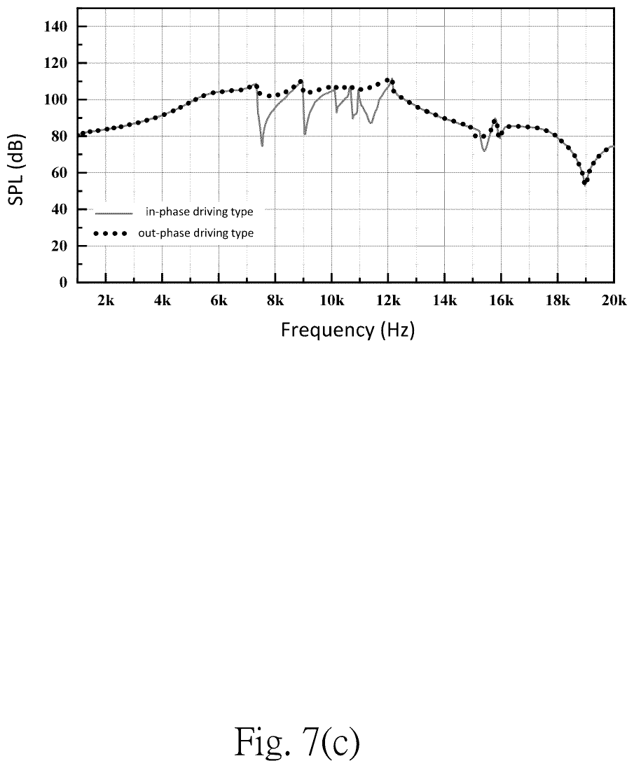

In addition, in order to overcome the problem in the previous technology that the cantilevers interfere with each other when vibrating, that is, when the driving frequency exceeds the resonant frequency, the structural vibration appears out-of-phase, resulting in a significant drop in sound pressure level, an out-of-phase driving method is proposed. That is to say, when the driving frequency of the driving signal received by each triangular cantilever exceeds the resonant frequency corresponding to the triangular cantilever, the phase of the driving signal (for example, the driving voltage signal) is reversed to prevent sound pressure level cancellation. Please refer to FIGS. 6(a)-(c). FIG. 6(a) is a reference type piezoelectric speaker for comparison with the piezoelectric speaker in the embodiment. FIGS. 6(b)-6(d) are simulation graphs showing the comparison of the sound pressure level performances of the piezoelectric speaker driven by the in-phase driving type and the out-of-phase driving type, and the reference type piezoelectric speaker. It should be noted that FIGS. 6(b)-6(d) are the simulation results after setting relevant parameters, wherein the 10 resonant peaks are caused by the original 8 structural resonant peaks plus the two Holmhertz cavity resonances in the human ear simulator. FIG. 6(e) is a schematic diagram of the out-of-phase driving method. In this embodiment, the piezoelectric speaker includes the feed lines 51-58 that are electrically connected to eight top electrodes located in the top electrode layer, so that the eight triangular cantilevers 41-48 receive eight driving signals respectively through the feed lines 51-58. These cantilevers occupy different areas within the frame due to designs such as the adjustable central position defined by the central triangular cantilever and the slits, and therefore correspond to different resonant frequencies or sound pressure level (SPL) poles. Referring to FIG. 6(e), when a driving frequency of the driving signal received by each of the central triangular cantilevers 43, 44, 42 and the peripheral triangular cantilevers 47 exceeds the corresponding resonance frequency f1-f8 of the cantilever, the sound pressure level cancellation is reduced by inverting the phase of the drive signal. It can be seen from FIGS. 6(a)-(e) and FIGS. 7(a)-(c) (described later) that the out-of-phase driving type improves the sound pressure level performance in the high-frequency range, and modulates the resonant frequency of the cantilever through out-of-phase driving to achieve appropriate sound pressure level. In other words, in order to obtain higher sound pressure levels, the out-of-phase driving type can increase the bandwidth of the high frequency range.

FIGS. 7(a)-(c) are measurement graphs illustrating the sound pressure level performances of another piezoelectric speaker driven by in-phase driving type and out-of-phase driving type, and the reference type piezoelectric speaker. The measurement method in FIGS. 7(a)-(c) is explained below. First, a piezoelectric speaker wire-bonded on a customized printed circuit board is used as the device under test (DUT). The DUT was then mounted on a 3D printed acrylic adapter to match the dimensions of the ear simulator. Next, secure the DUT to the standard coupler (G.R.A.S. RA0401) of the Human Ear Simulator System (G.R.A.S. 43AG-6) in the anechoic enclosure. When the driving signal is transmitted from the pulse spectrum analyzer (B & K) to the DUT, a sound pressure is generated, which travels through the human ear simulator to a standard pressure field microphone (G.R.A.S. 46BE). Next, the acoustic excitation is converted into an electrical signal and returned to the analyzer, where an electronic computer records and presents the frequency response. It should be pointed out in particular that since one of the cantilevers was damaged during the measurement and could not be driven, the resonance effect of the cavity during the measurement was not obvious, so the resonant frequencies shown in the figure are less than eight. However, even if the cantilever is damaged, it can still be seen that the embodiment of the present invention is superior to the reference type and the in-phase driving type.

The measurement results in FIGS. 7(a)-(c) show the frequency response driven at 0.707 Vrms. The in-phase driving type exhibits a maximum sound pressure level of 111 dB at its resonant frequency (10 kHz). It can be seen from FIG. 7 that the out-of-phase driving type in the embodiment has a bandwidth of 3.7˜14.0 kHz when the sound pressure level is above 90 dB, while the reference type has a bandwidth of 5.3˜12.6 kHz. In addition, the out-of-phase driving type in the embodiment exhibits a higher sound pressure level (more than 100 dB) in the frequency range of 5.2 to 12.6 kHz. Therefore, the out-of-phase driving method of the embodiment expands the bandwidth of a piezoelectric speaker with a limited area and can provide a high sound pressure level in a high frequency range, which is significantly better than the previous method.

That is, the present invention provides a piezoelectric speaker that exhibits a high sound pressure level surface in a high frequency range. In one embodiment of the present invention, the four central triangular cantilevers and the four peripheral triangular cantilevers of the piezoelectric speaker are disposed on the inside and outside of the frame respectively to modulate the piezoelectric speaker with eight different resonant frequencies. Moreover, due to the out-of-phase driving technology, the piezoelectric speaker can be operated with a wider bandwidth. The experimental results show that the ear simulator configured with the piezoelectric speaker of the embodiment achieves a bandwidth of 3.7˜14.0 KHz at a sound pressure level of more than 90 dB under the out-of-phase driving of 0.707 Vrms. The piezoelectric speaker of the embodiment has small size (4×4×0.5 mm³), low power consumption, and wide bandwidth in the high frequency range.

Although the frame in the embodiment of the present invention is a rectangle, if necessary, a circular, triangular, polygonal or even irregularly shaped frame with organic curves can be used. The cantilevers do not have to be triangular, if necessary, any adjustments can be made. Furthermore, although the diagonals of the central rectangular frame are parallel to the sides of the peripheral rectangular frame, they may not be parallel. If necessary, the relative position, shape and size of the central rectangular frame and the peripheral rectangular frame of the speaker can also be adjusted. Similarly, although the slits in the embodiment of the present invention are disposed outside the central rectangular frame, if necessary, their positions and shapes can also be changed. Furthermore, although there are eight cantilevers in the embodiment of the present invention, the number of cantilevers is not limited.

### Embodiments

1. A piezoelectric speaker comprising: a peripheral rectangular frame having four sides; a central rectangular frame disposed on the peripheral rectangular frame, wherein the central rectangular frame has four corners and four sides, and the four corners are connected to the four sides of the peripheral rectangular frame; four central triangular cantilevers disposed within the central rectangular frame, wherein each of the central triangular cantilevers has a vibrating end and a fixed end opposite to the vibrating end, and each of the fixed ends of the central triangular cantilevers is connected to the four sides of the central rectangular frame, the four vibrating ends of the four central triangular cantilevers are close to each other and fall short of contacting with each other, and the four central triangular cantilevers have different dimensions of their respective areas defined within the central rectangular frame; and four peripheral triangular cantilevers disposed between the peripheral rectangular frame and the central rectangular frame, wherein each of the four peripheral triangular cantilevers has a vibrating end and a fixed end opposite to the vibrating end, and the fixed ends of the four peripheral triangular cantilevers are respectively connected to the four sides of the central rectangular frame.

2. The piezoelectric speaker according to Embodiment 1, wherein a slit between the peripheral rectangular frame and the central rectangular frame is disposed adjacent to at least one of the four sides of the central rectangular frame; the slit has a length in a direction extending parallel to the corresponding side of the central rectangular frame; and the length is negatively correlated with the magnitude of a resonant frequency corresponding to the respective peripheral triangular cantilever.

3. The piezoelectric speaker according to Embodiment 1 or 2, wherein: the four central triangular cantilevers and the four peripheral triangular cantilevers are located on the same plane; a top electrode layer is disposed above the four central triangular cantilevers and the four peripheral triangular cantilevers; a bottom electrode layer is disposed below the four central triangular cantilevers and the four peripheral triangular cantilevers; and each of the four central triangular cantilevers corresponds to a resonant frequency and has a length from the vibrating end to the fixed end, and a square of the length is inversely proportional to the resonant frequency.

4. The piezoelectric speaker according to any one of Embodiments 1-3, further comprising eight feed lines electrically connected to eight top electrodes located in the top electrode layer, so that the four central triangular cantilevers and the four peripheral triangular cantilevers receive eight driving signals respectively through the eight feed lines.

5. The piezoelectric speaker according to any one of Embodiments 1-4, wherein each of the four central triangular cantilevers and the four peripheral triangular cantilevers corresponds to one resonance frequency; each of the four central triangular cantilevers and the four peripheral triangular cantilevers is made of a piezoelectric material; and the peripheral rectangular frame and the central rectangular frame are made of an SOI wafer.

6. The piezoelectric speaker according to any one of Embodiments 1-5, wherein a sound pressure level cancellation resulting from the piezoelectric speaker is reduced by inverting the phase of at least one of the eight driving signals when a driving frequency of the corresponding one of the eight driving signals received by the corresponding one of the four central triangular cantilevers and the four peripheral triangular cantilevers exceeds the resonant frequency of the corresponding triangular cantilever.

7. A method for manufacturing a piezoelectric speaker, comprising the steps of: (a) depositing a bottom electrode layer on a substrate and depositing a piezoelectric layer on the bottom electrode layer; (b) etching the piezoelectric layer to form a plurality of cantilever precursors; (c) forming a top electrode layer on the etched piezoelectric layer and patterning the top electrode layer; (d) patterning a first portion of the substrate and the bottom electrode layer; and (e) etching a second portion of the substrate to form a geometric frame, wherein the plurality of cantilever precursors are connected to the geometric frame to form a plurality of cantilevers, and the sides of the geometric frame present a form of a closed geometric figure.

8. The method according to Embodiment 7, wherein: the geometric frame comprises a central rectangular frame and a peripheral rectangular frame, wherein the peripheral rectangular frame has four sides, the central rectangular frame has four corners and four sides, and the four corners are respectively connected to the four sides of the peripheral rectangular frame; the substrate has an upper silicon device layer, a lower silicon device layer and a middle silicon dioxide layer located therebetween; and the first portion of the substrate is the upper silicon device layer, and the second portion of the substrate is the lower silicon device layer.

9. The method according to Embodiment 7 or 8, wherein the step (e) further comprises the step of: etching the lower silicon device layer and the middle silicon dioxide layer by a deep reactive ion etching to form a slit, wherein the slit has a length in a direction extending parallel to one of the four sides of the central rectangular frame, the respective side of the central rectangular frame is connected to a respective one of the plurality of cantilevers, and the length is negatively correlated with a resonant frequency of the corresponding cantilever.

10. The method according to any one of Embodiments 7-9, wherein: the peripheral rectangular frame and the central rectangular frame are made of an SOI wafer, the plurality of cantilevers include eight cantilevers; the four sides of the central rectangular frame and the four sides of the peripheral rectangular frame are connected to eight cantilevers respectively; and each of the eight cantilevers has a top electrode located on the top electrode layer.

11. The method according to any one of Embodiments 7-10, further comprising steps of: electrically connecting eight feed lines to the top electrodes respectively, so that the eight cantilevers receive eight driving signals respectively through the eight feed lines, wherein each of the plurality of cantilevers corresponds to a resonant frequency; and electrically connecting at least one ground electrode to the bottom electrode layer.

12. The method according to any one of Embodiments 7-11, wherein: the step (b) is to etch the piezoelectric layer by wet etching; the step (c) is to form the top electrode layer by evaporation; the step (d) is to dry etch the substrate using a high-density reactive ion etching system (HDP-RIE); and the step (d) is to etch the substrate using a deep reactive ion etching (DRIE).

13. A piezoelectric speaker, comprising: a frame having a sub-frame in a specific shape; and at least three inner cantilevers disposed in the frame, wherein each of the cantilevers has a vibrating end and a fixed end, each of the fixed ends of the cantilevers is connected to the sub-frame of the frame, areas respectively defined by the cantilevers within the frame have at least three dimensions, so that the piezoelectric speaker has at least three resonant frequencies.

14. The piezoelectric speaker according to Embodiment 13, wherein: the frame is a peripheral rectangular frame and the sub-frame is a central rectangular frame; and the central rectangular frame is disposed on the peripheral rectangular frame.

15. The piezoelectric speaker according to Embodiment 13 or 14, wherein: the peripheral rectangular frame has four sides; and the central rectangular frame has four corners and four sides, and the four corners are connected to the four sides of the peripheral rectangular frame.

16. The piezoelectric speaker according to any one of Embodiments 13-15, wherein the at least three peripheral cantilevers are disposed between the peripheral rectangular frame and the central rectangular frame, and each of the fixed ends of the at least three peripheral cantilevers is connected to a corresponding one of the four sides of the central rectangular frame.

17. The piezoelectric speaker according to any one of Embodiments 13-16, wherein: a slit between the peripheral rectangular frame and the central rectangular frame is disposed adjacent to at least one of the four sides of the central rectangular frame; the slit has a length in a direction extending parallel to the corresponding side of the at least one of the four sides of the central rectangular frame; and the length is negatively correlated with the magnitude of the resonant frequency corresponding to the respective peripheral cantilever adjacent to the slit.

18. The piezoelectric speaker according to any one of Embodiments 13-17, wherein: the at least three inner cantilevers and the at least three peripheral cantilevers are located on the same plane; a top electrode layer is disposed above the at least three inner cantilevers and the at least three peripheral cantilevers; a bottom electrode layer is disposed below the at least three inner cantilevers and the at least three peripheral cantilevers; and each of the three cantilevers corresponds to a resonant frequency and has a length from the vibrating end to the fixed end, and a square of the length is inversely proportional to the resonant frequency.

19. The piezoelectric speaker according to Embodiments 13-18, wherein: each of the three inner cantilevers and the at least three peripheral cantilevers corresponds to one resonance frequency; each of the three inner cantilevers and the at least three peripheral cantilevers is made of a piezoelectric material; and the peripheral rectangular frame and the central rectangular frame are made of an SOI wafer.

20. The piezoelectric speaker according to any one of Embodiments 13-19, further comprises feed lines electrically connected to top electrodes located in the top electrode layer, so that the three inner cantilevers and the at least three peripheral cantilevers receive driving signals respectively through the feed lines.

While the invention has been described in terms of what is presently considered to be the most practical and preferred embodiments, it is to be understood that the invention need not be limited to the disclosed embodiments. Therefore, it is intended to cover various modifications and similar configurations included within the spirit and scope of the appended claims, which are to be accorded with the broadest interpretation so as to encompass all such modifications and similar structures.

What is claimed is:

1. A piezoelectric speaker comprising:
a peripheral rectangular frame having four sides;
a central rectangular frame disposed on the peripheral rectangular frame, wherein the central rectangular frame has four corners and four sides, and the four corners are connected to the four sides of the peripheral rectangular frame;
four central triangular cantilevers disposed within the central rectangular frame, wherein each of the central triangular cantilevers has a vibrating end and a fixed end opposite to the vibrating end, and each of the fixed ends of the central triangular cantilevers is connected to the four sides of the central rectangular frame, the four vibrating ends of the four central triangular cantilevers are close to each other and fall short of contacting with each other, and the four central triangular cantilevers have different dimensions of their respective areas defined within the central rectangular frame; and
four peripheral triangular cantilevers disposed between the peripheral rectangular frame and the central rectangular frame, wherein each of the four peripheral triangular cantilevers has a vibrating end and a fixed end opposite to the vibrating end, and the fixed ends of the four peripheral triangular cantilevers are respectively connected to the four sides of the central rectangular frame.

2. The piezoelectric speaker according to claim 1, wherein:
a slit between the peripheral rectangular frame and the central rectangular frame is disposed adjacent to at least one of the four sides of the central rectangular frame;
the slit has a length in a direction extending parallel to the corresponding side of the central rectangular frame; and
the length is negatively correlated with the magnitude of a resonant frequency corresponding to the respective peripheral triangular cantilever.

3. The piezoelectric speaker as claimed in claim 1, wherein:
the four central triangular cantilevers and the four peripheral triangular cantilevers are located on the same plane;
a top electrode layer is disposed above the four central triangular cantilevers and the four peripheral triangular cantilevers;
a bottom electrode layer is disposed below the four central triangular cantilevers and the four peripheral triangular cantilevers; and
each of the four central triangular cantilevers corresponds to a resonant frequency and has a length from the vibrating end to the fixed end, and a square of the length is inversely proportional to the resonant frequency.

4. The piezoelectric speaker as claimed in claim 3, further comprising eight feed lines electrically connected to eight top electrodes located in the top electrode layer, so that the four central triangular cantilevers and the four peripheral triangular cantilevers receive eight driving signals respectively through the eight feed lines.

5. The piezoelectric speaker as claimed in claim 4, wherein:
each of the four central triangular cantilevers and the four peripheral triangular cantilevers corresponds to one resonance frequency;
each of the four central triangular cantilevers and the four peripheral triangular cantilevers is made of a piezoelectric material; and
the peripheral rectangular frame and the central rectangular frame are composed of an SOI wafer.

6. The piezoelectric speaker as claimed in claim 4, wherein a sound pressure level cancellation resulting from the piezoelectric speaker is reduced by inverting the phase of at least one of the eight driving signals when a driving frequency of the corresponding one of the eight driving signals received by the corresponding one of the four central triangular cantilevers and the four peripheral triangular cantilevers exceeds the resonant frequency of the corresponding triangular cantilever.

7. A method for manufacturing a piezoelectric speaker, comprising the steps of:
(a) depositing a bottom electrode layer on a substrate and depositing a piezoelectric layer on the bottom electrode layer;
(b) etching the piezoelectric layer to form a plurality of cantilever precursors;
(c) forming a top electrode layer on the etched piezoelectric layer and patterning the top electrode layer;
(d) patterning a first portion of the substrate and the bottom electrode layer; and
(e) etching a second portion of the substrate to form a geometric frame, wherein the plurality of cantilever precursors are connected to the geometric frame to form a plurality of cantilevers, and the sides of the geometric frame present a form of a closed geometric figure.

8. The method as claimed in claim 7, wherein:
the geometric frame comprises a central rectangular frame and a peripheral rectangular frame, wherein the peripheral rectangular frame has four sides, the central rectangular frame has four corners and four sides, and the four corners are respectively connected to the four sides of the peripheral rectangular frame;
the substrate has an upper silicon device layer, a lower silicon device layer and a middle silicon dioxide layer located therebetween; and
the first portion of the substrate is the upper silicon device layer, and the second portion of the substrate is the lower silicon device layer.

9. The method as claimed in claim 8, wherein the step (e) further comprises the step of:
etching the lower silicon device layer and the middle silicon dioxide layer by a deep reactive ion etching to form a slit, wherein the slit has a length in a direction extending parallel to one of the four sides of the central rectangular frame, the respective side of the central rectangular frame is connected to a respective one of the plurality of cantilevers, and the length is negatively correlated with a resonant frequency of the corresponding cantilever.

10. The method as claimed in claim 8, wherein:
the peripheral rectangular frame and the central rectangular frame are made of an SOI wafer,
the plurality of cantilevers include eight cantilevers;
the four sides of the central rectangular frame and the four sides of the peripheral rectangular frame are connected to eight cantilevers respectively; and
each of the eight cantilevers has a top electrode located on the top electrode layer.

11. The method as claimed in claim 8, further comprising steps of:
electrically connecting eight feed lines to the top electrodes respectively, so that the eight cantilevers receive eight driving signals respectively through the eight feed lines, wherein each of the plurality of cantilevers corresponds to a resonant frequency; and
electrically connecting at least one ground electrode to the bottom electrode layer.

12. The method as claimed in claim 7, wherein:
the step (b) is to etch the piezoelectric layer by wet etching;
the step (c) is to form the top electrode layer by evaporation;
the step (d) is to dry etch the substrate using a high-density reactive ion etching system (HDP-RIE); and
the step (d) is to etch the substrate using a deep reactive ion etching (DRIE).

13. A piezoelectric speaker, comprising:
a frame having a sub-frame in a specific shape; and
at least three inner cantilevers disposed in the frame, wherein each of the cantilevers has a vibrating end and a fixed end, each of the fixed ends of the cantilevers is connected to the sub-frame of the frame, areas respectively defined by the cantilevers within the frame have at least three dimensions, so that the piezoelectric speaker has at least three resonant frequencies.

14. The piezoelectric speaker as claimed in claim 13, wherein:
the frame is a peripheral rectangular frame and the sub-frame is a central rectangular frame; and
the central rectangular frame is disposed on the peripheral rectangular frame.

15. The piezoelectric speaker as claimed in claim 14, wherein:
the peripheral rectangular frame has four sides; and
the central rectangular frame has four corners and four sides, and the four corners are connected to the four sides of the peripheral rectangular frame.

16. The piezoelectric speaker according to claim 15, wherein the at least three peripheral cantilevers are disposed between the peripheral rectangular frame and the central rectangular frame, and each of the fixed ends of the at least three peripheral cantilevers is connected to a corresponding one of the four sides of the central rectangular frame.

17. The piezoelectric speaker as claimed in claim 16, wherein:
a slit between the peripheral rectangular frame and the central rectangular frame is disposed adjacent to at least one of the four sides of the central rectangular frame;
the slit has a length in a direction extending parallel to the corresponding side of the at least one of the four sides of the central rectangular frame; and
the length is negatively correlated with the magnitude of the resonant frequency corresponding to the respective peripheral cantilever adjacent to the slit.

18. The piezoelectric speaker as claimed in claim 16, wherein:
the at least three inner cantilevers and the at least three peripheral cantilevers are located on the same plane;
a top electrode layer is disposed above the at least three inner cantilevers and the at least three peripheral cantilevers;
a bottom electrode layer is disposed below the at least three inner cantilevers and the at least three peripheral cantilevers; and
each of the three cantilevers corresponds to a resonant frequency and has a length from the vibrating end to the fixed end, and a square of the length is inversely proportional to the resonant frequency.

19. The piezoelectric speaker as claimed in claim 14, wherein:
each of the three inner cantilevers and the at least three peripheral cantilevers corresponds to one resonance frequency;
each of the three inner cantilevers and the at least three peripheral cantilevers is made of a piezoelectric material; and
the peripheral rectangular frame and the central rectangular frame are made of an SOI wafer.

20. The piezoelectric speaker as claimed in claim 18, further comprises feed lines electrically connected to top electrodes located in the top electrode layer, so that the three inner cantilevers and the at least three peripheral cantilevers receive driving signals respectively through the feed lines.
